(19) United States
(12) Patent Application Publication
(10) Pub. No.: US 2025/0260120 A1
(43) Pub. Date: Aug. 14, 2025

(54) BATTERY CELL FOR A HIGH-VOLTAGE BATTERY AND MOTOR VEHICLE

(71) Applicant: AUDI AG, Ingolstadt (DE)

(72) Inventors: Michael ERNST, Wüstenrot (DE); Arjan STRATING, Weinsberg (DE)

(73) Assignee: AUDI AG, Ingolstadt (DE)

(21) Appl. No.: 19/014,357

(22) Filed: Jan. 9, 2025

(30) Foreign Application Priority Data
Feb. 9, 2024 (DE) 102024103656.7

(51) Int. Cl. H01M 50/342; B60R 16/033; H01M 50/103; H01M 50/586; H01M 50/59

(52) U.S. Cl. CPC H01M 50/3425; B60R 16/033; H01M 50/103; H01M 50/586; H01M 50/59; H01M 2220/20

(57) ABSTRACT

A battery cell which has a cell housing which encloses a cell interior. The cell housing has a first housing side in which a releasable cell degassing opening is arranged, and which includes an electrode layer arrangement arranged in the cell interior, and an insulation element made of an electrically insulating material arranged between the electrode layer arrangement and the first housing side in the cell interior. The insulation element has a bursting area which is directly opposite to the releasable cell degassing opening.

### FIELD

The invention relates to a battery cell having a cell housing that encloses a cell interior, wherein the cell housing has a first housing side in which a releasable cell degassing opening is arranged. The battery cell furthermore comprises an electrode layer arrangement arranged in the cell interior and an insulation element made of an electrically insulating material arranged between the electrode layer arrangement and the first housing side in the cell interior. Furthermore, the invention also relates to a motor vehicle.

### BACKGROUND

If a battery cell experiences thermal runaway, in particular in high-voltage batteries of motor vehicles, very high pressures arise in such a battery cell. In order to prevent uncontrolled bursting of such a battery cell, such a battery cell typically has a releasable cell degassing opening, for example in the form of a bursting membrane or a pressure relief valve, which can also be referred to as a vent or cell vent or vent opening or vent membrane or the like. When a certain overpressure occurs within the cell, this bursting membrane opens and/or ruptures, allowing hot gases and particles to escape from the cell through this then open bursting membrane. However, during such a thermal runaway of prismatic battery cells, it can often be observed that the cell cup, i.e. generally the cell housing, also partially melts away due to such hot gases. The cell cups are often manufactured from aluminum, which has a melting point in the range between 600 degrees Celsius and 650 degrees Celsius. The venting gases, i.e. the gases escaping from a cell undergoing thermal runaway, on the other hand, have a temperature level of approximately 1,200 degrees Celsius to 1,300 degrees Celsius and are thus significantly above the melting point of such a cell cup. This makes it difficult to control the outgassing of the cell via the releasable cell degassing opening. Such melting phenomena start, for example, at the edge of the vent in the cell lid and sometimes eat deep into the side walls of the cell cup. However, making a cell housing out of a more temperature-resistant metal, such as stainless steel, would greatly increase the cost of such a battery cell.

US 2018/0166676 A1 describes a battery cover structure having a cover and electrodes arranged thereon and an insulation element which is fastened below the cover. A degassing valve is arranged in the middle of the cover. Corresponding passage openings are arranged in the insulation elements below the cover.

### SUMMARY

The object of the present invention is to provide a battery cell and a motor vehicle which, in the most cost-effective and efficient manner possible, enable the most defined possible outgassing of a battery cell through a releasable cell degassing opening in case of thermal runaway of such a battery cell and at the same time prevent melting of the cell housing as much as possible or at least reduce its extent or delay it as much as possible.

A battery cell according to the invention comprises a cell housing which encloses a cell interior, wherein the cell housing has a first housing side in which a releasable cell degassing opening is arranged, an electrode layer arrangement arranged in the cell interior, and an insulation element made of an electrically insulating material arranged between the electrode layer arrangement and the first housing side in the cell interior. In addition, the insulation element has a bursting area that is directly opposite to the releasable cell degassing opening.

The invention is based on several findings: Battery cells often comprise an insulation element in their cell interior, for example made of plastic, which is arranged between an electrode layer arrangement, for example an electrode coil with an active material and/or an electrode stack with active material, and the cell cup, that is to say generally the cell housing of such a battery cell. This insulation element has the main task of ensuring the electrical insulation properties within such a battery cell. In addition, the invention is based on the finding that the design and layout of such an insulation element influences the melting properties of the cell housing during outgassing of a battery cell. If such an insulation element is embodied as closed in an area directly opposite to the releasable cell degassing opening, no direct passage of gas through this insulation element and through the releasable cell degassing opening is possible in case of degassing. The escaping gas therefore has to take a detour around the insulation element, which promotes lateral melting of the cell housing. The design of such an insulation element having a permanent opening, on the other hand, in case of degassing, under certain circumstances allows an unobstructed direct flow against the releasable cell degassing opening of the cell separation element, which, however, also promotes melting of the cell housing starting from the edge area of the releasable cell degassing opening due to the gas flow impacting thereon unobstructed, and above all a permanent opening in the insulation element impairs its insulation function in normal operation or reduces the insulation safety. The design according to the invention of the area of the insulation element opposite to the releasable cell degassing opening having a bursting area, which is therefore essentially or completely closed during normal operation and only allows a simple bursting and thus flow through the insulation element in case of outgassing, enables undiminished insulation safety during normal operation and simple outgassing of the battery cell in case of thermal runaway, in which a lateral flow around the insulation element and a resulting melting of the cell housing can be prevented more efficiently or at least reduced in extent or in time. In particular, the bursting area enables a direct outflow of gases from the cell through the releasable cell degassing opening without the insulation element being in the way of such a direct outflow path. In addition, an advantageous design of the bursting area, which can also be referred to as the bursting element of the insulation element, can provide an additional protective and/or shielding function for the cell housing, in particular the edge of the releasable cell degassing opening, when the battery cell outgasses, as will be explained in more detail later. In particular, for example, in case of bursting of the bursting area, it can be destroyed or torn open in such a way that parts of this bursting area open or unfold in such a way that the edge of the releasable cell degassing opening can simultaneously be protected, at least temporarily, from direct impact of the gases. This can advantageously also counteract melting of the cell housing in case of degassing starting from the edge area of the releasable cell degassing opening. This design of the insulation element can advantageously promote targeted outgassing of the battery cell in case of thermal runaway through the releasable cell degassing opening, in a particularly simple and efficient manner.

In general, the battery cell can be designed, for example, as a prismatic battery cell or pouch cell or round cell. The battery cell is preferably designed as a prismatic battery cell. In this case, the cell housing has an essentially cuboid geometry. In this case, the first cell housing side can represent any of the six cell housing sides of such a cuboid cell housing. The cell housing can have a housing cover which comprises a first cell housing side and a cell cup comprising the remaining five of these cell housing sides. The releasable cell degassing opening and in particular also two cell poles of the cell can be arranged on the housing cover. The insulation element can be part of a cover assembly comprising the housing cover and optionally the cell poles. However, the cell housing can also be designed or constructed differently. Preferably, the first housing side represents a housing side that does not belong to one of the two cell housing sides having the largest surface area. The releasable cell degassing opening can, for example, be located between the two cell poles of the battery cell on this first housing side. The battery cell can be formed, for example, as a lithium-ion battery cell. The cell housing can be made of aluminum. This enables a particularly weight-saving and cost-effective design. But other materials are also possible.

An electrode layer arrangement can be understood in particular as an electrode stack or an electrode coil. Such an electrode layer arrangement can comprise several electrode layers, for example, an anode layer, a cathode layer, and at least one or more separator layers that separate the anode layer from the electrode layer. Such a layer arrangement can be wound, which then represents an electrode coil, or it can be layered several times on top of one another. Which then accordingly represents an electrode stack. Such an electrode layer arrangement can be electrically connected to the respective poles of the battery cell via corresponding arrester elements. There can also be an electrolyte in the cell interior.

The insulation element is arranged between such an electrode layer arrangement and the first housing side. As a result, the insulation element can avoid or prevent direct contact between the electrode layer arrangement and the first housing side. The insulation element can, for example, be manufactured from a plastic. It is very advantageous if the insulation element is made of a plastic that is as fire-resistant and/or flame-retardant as possible, in particular a plastic according to the V0 class. The insulation element can, for example, have openings which are directly opposite to the respective cell poles arranged on the first housing side in order to enable, for example, contacting of the electrode layer arrangement with a respective cell pole. However, such contacting can also be implemented in other ways. In general, it is very advantageous and therefore preferred if the insulation element has as few permanent openings as possible and, if possible, is embodied as completely closed, at least in as large a central area as possible adjacent to the bursting area.

The insulation element can, for example, be plate-shaped. In particular, it can be aligned substantially parallel to the first housing side. The first housing side can, for example, have a first inner side facing toward the cell interior. The insulation element can extend over almost the entire or the entire first inner side of the first housing side.

The battery cell can also optionally comprise one or more further insulation elements at another location inside the cell, although this is not important within the scope of the present invention.

The releasable cell degassing opening can be designed, for example, as a bursting membrane or pressure relief valve or the like. The releasable cell degassing opening can, as already described at the beginning, also be referred to as a cell vent or venting opening or the like. For example, a passively opening predetermined breaking point that opens depending on pressure can be provided in the first housing side by the releasable cell degassing opening.

A bursting area of the insulation element can also be understood as a predetermined breaking point. The insulation element is designed in the bursting area in such a way that in case of a thermal runaway of the battery cell or in case of gas escaping from the battery cell, the insulation element opens in this bursting area and is, for example, partially destroyed or ruptured or the like. The bursting area can, for example, be embodied having a weakened material. Various design options of the bursting area are explained in more detail below. The bursting area is preferably embodied as a single piece with the other areas of the insulation element. The bursting area is therefore preferably not provided by a separate component. The bursting area and the remaining parts of the insulation element can be manufactured from the same material.

In a further particularly advantageous embodiment of the invention, a surface area of the bursting area is smaller than a surface area of the releasable cell degassing opening, in particular wherein the bursting area lies completely within a projection area of the insulation element, which results from an imaginary vertical projection of the releasable cell degassing opening onto the insulation element. This vertical projection can, for example, refer to a first direction. The bursting area can, for example, be located directly opposite to the releasable cell degassing opening with respect to this first direction. The bursting area is therefore preferably smaller than the releasable cell degassing opening with respect to a second and/or third direction, which are each perpendicular to the first direction and are defined perpendicular to one another. This has the great advantage that, in case of outgassing of the battery cell, a direct flow against the edge area of the releasable cell degassing opening can be prevented at least temporarily by the insulation element, since the edge area of the insulation element surrounding the bursting area covers the edge area of the releasable cell degassing opening due to the smaller bursting area in the degassing direction, which can correspond to the above-mentioned first direction. The melting of the cell housing in the edge area of the releasable cell degassing opening can thus be prevented more efficiently or at least delayed for a longer time.

According to a further advantageous embodiment of the invention, the bursting area is designed as a local material weakening. Such a material weakening can be provided, for example, by a reduced wall thickness of the insulation element. The insulation element can therefore have a lesser wall thickness in the bursting area than in other areas of the insulation element. In case of outgassing from the battery cell, the insulation element is first penetrated by the outflowing gas in the bursting area due to this weakening of the material. This allows targeted gas guidance to be provided.

It can furthermore be provided that the material weakening is provided by a reduced wall thickness of the insulation element in the entire bursting area. In other words, the entire bursting area can be embodied having a reduced wall thickness in relation to the other areas of the insulation element. Within the bursting area, the insulation element can, for example, be designed having a constant wall thickness. This allows a particularly simple design of the bursting area.

According to a further advantageous embodiment of the invention, the bursting area is formed having a material weakening which extends locally along at least one line extending in the bursting area and/or a line arrangement, for example a line formation. A boundary contour surrounding the bursting area can also be understood as such a line. The bursting area can therefore be designed in such a way that it does not have an overall reduced wall thickness, but only, for example, a reduced wall thickness along one or more such defined lines or a line arrangement having multiple lines. In case of bursting, this advantageously enables a targeted tearing or separation of the bursting area along this defined line and/or lines of the line arrangement. This allows a more controlled and defined opening behavior of the bursting area to be achieved. For example, the closed boundary contour surrounding the bursting area can be designed as such a predetermined breaking line, for example, as a notched line, or as a groove or perforation line extending along the boundary line. In case of degassing, this enables, for example, a complete separation of the bursting area within this boundary contour. The material weakening can therefore also be provided along the boundary contour surrounding the bursting area in the circumferential direction, in particular wherein the line arrangement encloses the boundary contour completely or only in sections. Only the boundary contour can also be designed as a notch. In case of degassing, for example, the bursting area then separates completely from the rest of the insulation element.

According to a further advantageous embodiment of the invention, the material weakening is designed as a continuously extending notch or a notch interrupted once or repeatedly, in particular along the line extending in the bursting area and/or the line arrangement. A notch can be understood, for example, as a type of groove or material taper that does not completely penetrate the insulation element in this area, however. The insulation element is therefore closed in the area of this notch in the normal state. In the area of this notch, the insulation element therefore has a reduced wall thickness. When pressure is applied, the insulation element will in all probability tear or open in the area of this notch. In order to enable the bursting area to tear or open along a defined line and/or a line formation, such a line or the lines of such a line formation or line arrangement can be formed having a continuously extending notch or groove or also with notches or groove sections provided in some areas and spaced apart from one another, which therefore have a certain distance from one another.

According to a further advantageous embodiment of the invention, the material weakening can also be designed as a continuously extending slot that completely penetrates the insulation element along at least one line extending in the bursting area and/or the line arrangement. The bursting area can thus also be embodied having a slot penetrating the insulation element. This facilitates the opening of the bursting area in case of degassing, while at the same time such a slot only creates a slight opening in the insulation element. According to a further advantageous embodiment of the invention, the material weakening is formed as a perforation line by means of perforations and/or slots that completely penetrate the insulation element, in particular again along the line and/or the line arrangement. The bursting area can thus also be embodied having one or more such perforation lines. This also makes deliberate opening along such defined lines possible, while the opening area of the insulation element is normally reduced to a minimum.

The above-mentioned design variants of material weakening can also be combined with each other in any way in the same bursting area.

However, it is very advantageous if the insulation element has a material weakening in the bursting area that does not completely penetrate the insulation element, for example in the form of the notch or groove described above. This maximizes the insulating protective effect of the insulation element in the normal state.

According to a further advantageous embodiment of the invention, the line arrangement is designed such that the bursting area comprises at least one flap adjacent to a folding edge, wherein the folding edge and a contour of the flap are part of the line arrangement, in particular wherein the line arrangement is designed such that the bursting area is divided into multiple flaps adjacent to respective folding edges. Such flaps or folding edges can be easily implemented by means of the measures described above, namely by designing the lines of the line arrangement as corresponding material weakenings, for example, in the form of notches, slots, perforations, or the like. In particular, a folding edge can also be provided in a simple manner by a groove or notch along a line and/or as another type of linear material weakening. This allows for easier folding over of such a flap around such a defined fold edge. The folding edge can thus provide a kind of hinge or hinge effect.

The remaining contour of such a flap can also be designed as a corresponding material weakening, for example a groove, notch, perforation, slot, or the like. The contour part of the flap which is intended to tear open in case of degassing, i.e. to detach from other parts of the insulation element, can, for example, be arranged in a region of the bursting area which is exposed to a higher gas pressure, for example more centrally in relation to the releasable cell degassing opening. The folding edges, however, can be positioned closer to the edge area of the bursting area or represent such an edge area or part of a boundary contour of the bursting area. The contour lines of the flap, along which the bursting area is to rupture in case of degassing, can also be designed having a more extensive material weakening than the folding edges. In other words, for example, the folding edges can be embodied having a reduced wall thickness in relation to the areas of the insulation element located outside the bursting area, while the contour of the flap or flaps has a reduced wall thickness in relation to the folding edges. For example, a folding edge can be designed as a groove that is less deep than a groove along the contour of the flap or flaps.

The design of the bursting element, i.e. the bursting area, having such flaps also has the great advantage that the flaps of the bursting area can provide additional protection for the edge area of the releasable cell degassing opening. When the flaps are folded open in case of degassing, the flaps of the bursting area lie over the edge area of the releasable cell degassing opening. This provides additional protection for this edge area from the outflowing hot gas, at least temporarily. This means that melting of the housing can be efficiently prevented for a longer period of time. This described protective effect by folding open the parts of the bursting area is particularly efficient above all when the bursting area is designed somewhat smaller than the releasable cell degassing opening.

Furthermore, it is advantageous if the material weakening providing the folding edge, e.g., the notch or groove, is located on a side of the insulation element facing away from the first housing side. This makes it easier to open the flaps.

According to a further advantageous embodiment of the invention, the folding edge is provided as part of the line arrangement by a boundary contour extending around the bursting area in a circumferential direction, in particular wherein the line arrangement encloses the boundary contour completely or only in sections. In other words, the boundary contour surrounding the bursting area is particularly suitable as a folding edge. The boundary contour can function as such a folding edge completely or only partially or in sections. For example, the bursting area can rupture in the middle area and the resulting sections can fold open as flaps around the boundary contour of the bursting area. The formation of the boundary contour completely or at least partially or in sections as such a folding edge enables a particularly advantageous rupturing and unfolding of the flaps resulting upon the bursting.

According to a further advantageous embodiment of the invention, the line arrangement comprises a first line which extends straight in a certain direction through a large part of the bursting area or the entire bursting area or almost completely through it, for example, by at least 80%. This can, for example, be the second direction or third direction defined above. Furthermore, the bursting area is preferably geometrically adapted to the releasable cell degassing opening. This is, for example, elongated and/or oval in shape and has, for example, a larger dimension in a second direction than in the third direction. Accordingly, it is then also preferred that the bursting area has a larger dimension in the second direction than in the third direction. In this case, it is still very advantageous if the first line, for example, is a line extending in the second direction. The first line therefore crosses the entire bursting area or almost the entire bursting area in a straight line, for example, in the second direction. The first line is preferably positioned as centrally as possible in relation to the third direction. The bursting area is so to speak divided into two halves by the first line. This advantageously makes it possible to allow the bursting area to rupture along its center line in case of degassing. The flaps thus created then preferably fold outwards, as already described above, around the folding edges extending along the peripheral contour or boundary contour and thus protect the edge area of the then exposed cell degassing opening at least partially, in particular largely.

According to a further advantageous embodiment of the invention, the line arrangement comprises a second and a third line which are parallel to one another and cross the first line perpendicularly, and in particular pass through almost or completely the entire bursting area, in particular in the third direction defined above. By means of such a line arrangement, the bursting area can be so to speak divided into six sub-areas, which in case of bursting then correspond to six flaps that can fold around the outer contour of the bursting area. This design is particularly advantageous in the case of an oval-shaped bursting area. This allows for simplified folding open of the bursting area, especially in the area of curves. This line arrangement can provide a double-T contour, so to speak. This allows the protective effect for the released cell degassing opening to be maximized in case of degassing.

Furthermore, the invention also relates to a battery for a motor vehicle having a battery cell according to the invention or one of its embodiments. The battery can be designed, for example, as a high-voltage battery.

Furthermore, the invention also relates to a motor vehicle having a battery cell according to the invention or one of its embodiments. In particular, the motor vehicle can comprise a battery according to the invention or one of its embodiments.

The invention also includes refinements of the battery according to the invention, which have features as already described in the context of the refinements of the battery cell according to the invention. For this reason, the corresponding refinements of the battery according to the invention are not described again here.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic representation of a battery cell according to an exemplary embodiment of the invention;

FIG. 2 shows a schematic representation of an insulation element for a battery cell according to an exemplary embodiment of the invention;

FIG. 3 shows a schematic cross-sectional representation of a battery cell according to an exemplary embodiment of the invention in a normal operating state;

FIG. 4 shows a schematic representation of the battery cell from FIG. 3 in case of degassing according to an exemplary embodiment of the invention;

FIG. 5 shows a schematic representation of an insulation element for a battery cell according to a further exemplary embodiment of the invention;

FIG. 6 shows a schematic cross-sectional representation of a battery cell according to an exemplary embodiment of the invention in a normal operating state; and

FIG. 7 shows a schematic cross-sectional representation of the battery cell from FIG. 6 in case of degassing according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

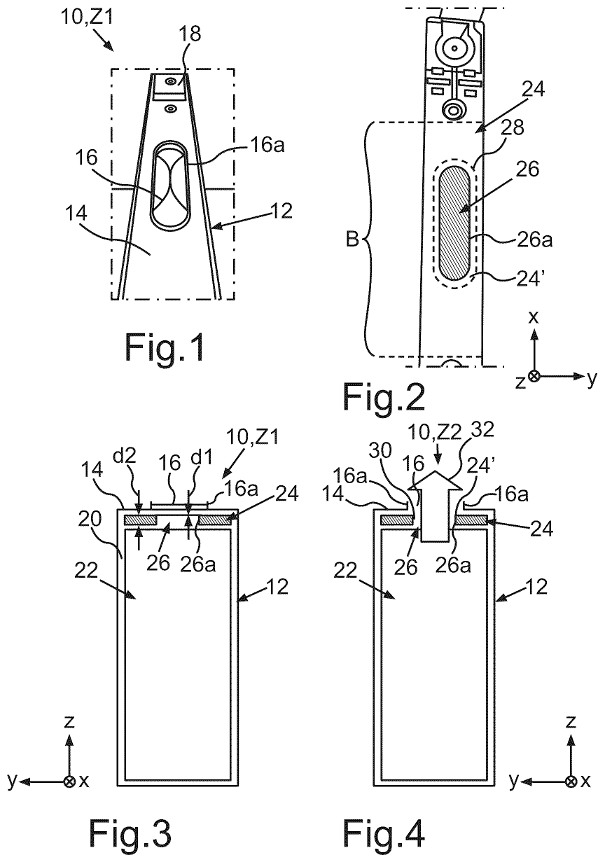

FIG. 1 shows a schematic representation of a battery cell 10 in a top view diagonally from above according to an exemplary embodiment of the invention. The battery cell 10 has a cell housing 12, which is made of a metallic material, for example aluminum. The housing 12 comprises a first housing side 14, on which a releasable cell degassing opening 16 is arranged, and which in this example is designed as a bursting element or bursting membrane 16 having an edge 16a as part of the housing 12. The battery cell 10 also comprises two cell poles 18, of which only one is visible in the present illustration. In this example, both of these cell poles 18 are also arranged on the first housing side 14. The cell poles 18 are electrically conductively connected to an electrode layer arrangement 22 located in the cell interior 20 (cf. FIG. 3).

FIG. 3 shows, for example, a schematic cross-sectional representation of such a battery cell 10 in a normal operating state Z1, in which the releasable cell degassing opening 16 is closed. The electrode layer arrangement 22 comprises an active material. In addition, an electrolyte of the battery cell 10 may also be present in the cell interior 20. Furthermore, the battery cell 10 comprises an insulation element 24 which is arranged between the electrode layer arrangement 22 and the first housing side 14. The insulation element 24 is formed, for example, from a plastic.

In case of a thermal runaway, depending on the design, conventional battery cells may experience a design conflict of the insulation element with regard to the insulating properties and the freest possible outflow of the venting gases and the cell cup integrity, i.e. the integrity of the cell housing. In extreme cases, a closed design of such an insulation element can lead to a blockage of the vent, i.e. the releasable cell degassing opening, which could cause volatile, sometimes expressive outgassing behavior. A loss of cell cup integrity due to melting processes drastically reduces the controllability of thermal propagation phenomena. At the cell cup areas which are locally melted away, the thermally insulating cell separation elements, which are often located between battery cells arranged adjacent to each other, are then attacked by the abrasive venting gases, i.e. by the escaping gas stream including the abrasive particles contained therein, and gradually lose their insulating properties. This makes propagation to a neighboring cell increasingly probable. Under these circumstances, it has been very difficult to ensure a safe and simultaneously cost-effective design of fire safety in the system.

The invention or its embodiments now advantageously make it possible to improve the outgassing behavior of such a battery cell 10 in a simple and efficient manner. This is made possible in particular by a specific design of the insulation element 24. This now advantageously has a bursting area 26, as shown for example in FIG. 2.

FIG. 2 shows a schematic representation of an insulation element 24 for a battery cell 10 according to one exemplary embodiment of the invention. The insulation element 24 is shown as an example in a top view from below, so to speak from the cell interior 20 of the cell housing 12. The insulation element 24 thus has a bursting area 26 which is directly opposite the releasable cell degassing opening 16 with respect to a specific direction, in the present case the z-direction shown. The x-direction shown can moreover correspond to the previously defined second direction and the y-direction shown to the previously defined third direction. The coordinate systems shown in the figures can additionally be Cartesian coordinate systems.

Furthermore, a projection area is illustrated by the dashed line 28 shown, which results from a vertical projection of the releasable cell degassing opening 16 against the z-direction onto the insulation element 24. Preferably, the bursting area 26, which is delimited by a circumferential boundary line 26a, is designed geometrically similar to the releasable cell degassing opening 16 and is also smaller, in particular both in relation to the x-direction shown and in relation to the y-direction shown. The bursting area 26 is therefore completely within the projection area 28. This is very advantageous since it allows a special protective function to be provided for the releasable cell degassing opening 16, in particular the edge area 16a (cf. FIG. 1), which is provided by the cell housing 12. This prevents gas from flowing directly against this edge area 16a in case of degassing through the part 24′ of the insulation element 24 which directly surrounds and adjoins the bursting area 26. The bursting area 26 is also designed such that in the normal operating state Z1, i.e. when the cell 10 does not thermally run away, it is closed essentially completely or completely, as shown for example in FIG. 3, and in the degassing case Z2, as shown schematically in FIG. 4, it releases a passage opening 30 through the insulation element 24. For this purpose, the bursting area 26 can be at least partially destroyed and/or rupture and/or bend open or the like.

FIG. 3 shows a schematic cross-sectional representation of a battery cell 10 having an insulation element 24, which has such a bursting area 26 arranged directly below the releasable cell degassing opening 16. In this example, the bursting area 26 is designed such that it has a wall thickness d1 that is less than a wall thickness d2 of the insulation element 24 outside this bursting area 26. In particular, in this example, the bursting area 26 is designed having a constant wall thickness d1. The bursting area 26 is therefore designed having very thin walls in this region, so that in case of a thermal runaway of the battery cell 10, as shown in FIG. 4, it can easily be broken through or penetrated by the outflowing gas stream 32. In the example shown in FIG. 3 and FIG. 4, the bursting area 26 can also be completely separated from the remaining insulation element 24 in the degassing case Z2. The part 24′ of the insulation element 24 which remains at least temporarily intact protects, as can also be seen in FIG. 4, the edge area 16a of the cell degassing opening 16, which is then released in the degassing case Z2.

However, the bursting area 26 can also be designed differently. In particular, this does not necessarily have to be designed globally as a material weakening, but can, for example, also comprise a local material weakening that extends along a line and/or a line arrangement.

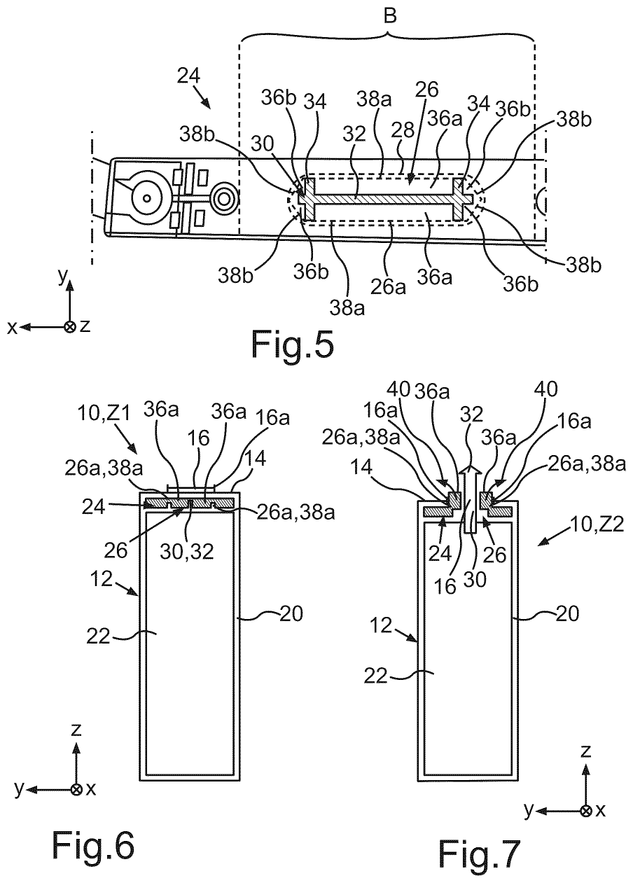

FIG. 5 shows a schematic representation of an insulation element 24 according to a further exemplary embodiment of the invention. It can be designed in particular as described above, except for the differences described below. In this example, the boundary contour 26a of the bursting area 26 is illustrated by a dashed line and the boundary of the projection area 28 is also illustrated by a dashed line. In this case too, it is preferred that the bursting area 26 is smaller than this projection area 28. The bursting area 26 is now not embodied as a global material weakening, but rather the bursting area 26 comprises a line arrangement 30, by means of which such a material weakening of the bursting area 26 is implemented. In other words, the material weakening of the bursting area 26 can be restricted to this line arrangement 30. In this example, the line arrangement 30 comprises a first line 32 which extends essentially in a straight line in the second direction, that is to say in the x-direction, in particular over a large part of the bursting area 26, in particular over almost the entire bursting area 26. Furthermore, the line arrangement 30 comprises two second lines 34 which are spaced apart from one another in the x-direction, are arranged parallel to one another, and in particular intersect the first line 32 perpendicularly. These second lines 34 extend, for example, essentially in a straight line in the y-direction, in particular over the entire width of the bursting area 26 in the y-direction. As a result, the bursting area 26 can be subdivided into six areas 36a, 36b, namely two large areas 36a and four smaller areas 36b. In addition, a part of the boundary contour 26a of the bursting area 26, which in particular can also be regarded as part of the line arrangement 30, can be formed with a material weakening, for example a groove or notch or the like. At least the sections of this boundary contour extending in the x-direction are formed with such a material weakening and provide a corresponding folding edge 38a. The resulting material weakening for providing such a folding edge 38a can be less than the material weakening along the first and second lines 32, 34. As a result, a hinge effect for the flaps 36a can be provided by these folding edges 38a. Optionally, the boundary contour 26a in the area of the small flaps 36b can also be embodied having a corresponding material weakening to provide a corresponding folding edge 38b. Due to this folding-open effect in the degassing case Z2, additional protection can be provided for the edge area 16a of the releasable cell degassing opening 16.

FIG. 6 shows a schematic representation of a battery cell 10 having an insulation element 24, which can be designed as described for FIG. 5. In FIG. 6, the material weakening for providing the folding edges 38a can be seen in particular, as well as the material weakening for providing the predetermined breaking line 32. In particular, FIG. 6 shows the battery cell 10 again in a normal operating state Z1, while FIG. 7 illustrates this battery cell 10 in the degassing case Z2. FIG. 7 shows the insulation element 24 with turned-out wings 36a during the thermal runaway Z2. These wings protect the cell cup 12 and the vent 16 from the high temperatures of the outflowing venting gases 32. Parts of the bursting area 24, namely the flaps 36a, are folded upwards around the folded edges 38a and thereby lie protectively over the edge area 16a of the releasable cell degassing opening 16, in particular the cell degassing opening 16 that is then released in this case. The folding open is illustrated by the arrows 40. The folded edges 38a, 38b thus result in hinge areas. The battery cell 10 can moreover be designed as described above.

Furthermore, it is very advantageous if the insulation element 24 is generally having as few through openings and the like as possible. In the example shown in FIG. 2 and FIG. 5, a central area B of the insulation element 24 is illustrated, which can extend over the entire width in the y-direction and, for example, over a large part of the length of the insulation element 24 in the x-direction. The bursting area 26 is provided in this central area B. The partial area of the insulation element 24 surrounding the bursting area 26 within this area B is preferably designed without any openings or perforations or the like, but is completely closed. The bursting area 26 can, under certain circumstances, be embodied having smaller openings, for example having slots and/or perforations to provide the material weakening described above.

In the insulation element 24, a predetermined breaking point in the form of the bursting area 26 can advantageously be arranged, which opens in case of thermal runaway. The predetermined breaking point 26 in the insulation element 24 can be geometrically smaller in circumference or in terms of its dimensions than the projected opening 28 of the vent 16. This can prevent the hot venting gases 32 from flowing directly against the metal of the cell cup 12 and softening it. A loss of cell cup integrity due to melting processes can thus be decisively avoided or at least delayed. The predetermined breaking point 26 in the insulation element 24 can be implemented either by a local thinning of the surface of the bursting area 24 or in the form of a geometric notch along certain bursting lines and/or the edge area 26a of the targeted opening 30. In normal operation of the cell 10, which is illustrated by the state Z1, the insulation element 24 performs the task of internal cell electrical insulation unimpaired. For example, a structure 30 can be introduced into the insulation element 24, in which structure the previously described line arrangement 30 having the material weakening can be formed, and which opens during thermal runaway, which is illustrated by the state Z2, and can be elastically bent by the outflowing venting gases 32 such that the two wings 36a are positioned protectively in front of the metallic edges 16a of the vent 16. This creates a thermal insulation layer which protects the material of the cell cup 12 and the vent 16 against the very high gas temperatures and significantly delays or, ideally, prevents the melting processes in the cell cup 12. This double-T geometry of the line arrangement 30 can be embodied as a slot and/or perforation or as a taper or generally as a predetermined breaking point in the insulation element 24.

Overall, the examples show how the invention can provide an internal cell insulation element with a protective function in case of thermal runaway of a battery cell. The described design features can largely resolve the conflicting objectives between electrical insulation, free outgassing, and cell cup integrity. This results in improved outgassing behavior while maintaining the electrical safety of a prismatic battery cell, clear and reproducible output behavior, improved cell cup integrity due to delayed melting processes, and a simpler and more cost-effective module and assembly design by eliminating expensive and highly complex measures. For the design of the insulation element, the following features in particular can be implemented and, if necessary, combined: A closed embodiment, in particular without openings or holes outside the venting zone, a predetermined breaking point in the area of the vent of the prismatic cell and a protective function of the thermally stable plastic of the insulation element.

1. A battery cell, comprising
a cell housing which encloses a cell interior, wherein the cell housing has a first housing side in which a releasable cell degassing opening is arranged,
an electrode layer arrangement arranged in the cell interior, and
an insulation element made of an electrically insulating material arranged between the electrode layer arrangement and the first housing side in the cell interior,
wherein the insulation element has a bursting area which is directly opposite to the releasable cell degassing opening.

2. The battery cell as claimed in claim 1, a surface area of the bursting area is smaller than a surface area of the releasable cell degassing opening, in particular wherein the bursting area lies completely within a projection area of the insulation element which results from an imaginary vertical projection of the releasable cell degassing opening onto the insulation element.

3. The battery cell as claimed in claim 1, wherein the bursting area is formed as a local material weakening, in particular wherein the material weakening is provided by a reduced wall thickness of the insulation element in the entire bursting area.

4. The battery cell as claimed in claim 1, wherein the bursting area is formed having a material weakening which extends locally in the bursting area along at least one line extending in the bursting area and/or a line arrangement.

5. The battery cell as claimed in claim 4, wherein the weakening of the material
is designed as a notch extending uninterrupted or as a notch interrupted once or multiple times;
is designed as a slot extending uninterrupted that completely penetrates the insulation element; and/or
is designed as a perforation line having perforations that completely penetrate the insulation element.

6. The battery cell as claimed in claim 4, wherein the line arrangement is designed such that the bursting area comprises at least one flap adjacent to a folding edge, wherein the folding edge and a contour of the flap are part of the line arrangement, in particular wherein the line arrangement is designed such that the bursting area is divided into a plurality of flaps adjacent to respective folding edges.

7. The battery cell as claimed in claim 6, wherein the folding edge is provided as part of the line arrangement by a boundary contour extending around the bursting area in the circumferential direction, in particular wherein the line arrangement encloses the boundary contour completely or only in sections.

8. The battery cell as claimed in claim 4, wherein the line arrangement comprises a first line which extends in a straight line through the entire bursting area or at least a large part of the entire bursting area in a specific direction.

9. The battery cell as claimed in claim 4, wherein the line arrangement comprises a second and a third line which are parallel to one another and cross the first line perpendicularly, and in particular extend through the entire bursting area.

10. A motor vehicle having a battery cell as claimed in claim 1.

11. The battery cell as claimed in claim 2, wherein the bursting area is formed as a local material weakening, in particular wherein the material weakening is provided by a reduced wall thickness of the insulation element in the entire bursting area.

12. The battery cell as claimed in claim 2, wherein the bursting area is formed having a material weakening which extends locally in the bursting area along at least one line extending in the bursting area and/or a line arrangement.

13. The battery cell as claimed in claim 3, wherein the bursting area is formed having a material weakening which extends locally in the bursting area along at least one line extending in the bursting area and/or a line arrangement.

14. The battery cell as claimed in claim 5, wherein the line arrangement is designed such that the bursting area comprises at least one flap adjacent to a folding edge, wherein the folding edge and a contour of the flap are part of the line arrangement, in particular wherein the line arrangement is designed such that the bursting area is divided into a plurality of flaps adjacent to respective folding edges.

15. The battery cell as claimed in claim 5, wherein the line arrangement comprises a first line which extends in a straight line through the entire bursting area or at least a large part of the entire bursting area in a specific direction.

16. The battery cell as claimed in claim 6, wherein the line arrangement comprises a first line which extends in a straight line through the entire bursting area or at least a large part of the entire bursting area in a specific direction.

17. The battery cell as claimed in claim 7, wherein the line arrangement comprises a first line which extends in a straight line through the entire bursting area or at least a large part of the entire bursting area in a specific direction.

18. The battery cell as claimed in claim 5, wherein the line arrangement comprises a second and a third line which are parallel to one another and cross the first line perpendicularly, and in particular extend through the entire bursting area.

19. The battery cell as claimed in claim 6, wherein the line arrangement comprises a second and a third line which are parallel to one another and cross the first line perpendicularly, and in particular extend through the entire bursting area.

20. The battery cell as claimed in claim 7, wherein the line arrangement comprises a second and a third line which are parallel to one another and cross the first line perpendicularly, and in particular extend through the entire bursting area.
